(19) United States
(12) Patent Application Publication
(10) Pub. No.: US 2022/0041124 A1
(43) Pub. Date: Feb. 10, 2022

(54) Mobile platform and driving method of mobile platform

(71) Applicant: Coretronic Corporation, Hsin-Chu (TW)

(72) Inventors: WEI-CHEN LIAO, Hsin-Chu (TW); EN-HUAI HSU, Hsin-Chu (TW)

(21) Appl. No.: 17/391,028

(22) Filed: Aug. 2, 2021

(30) Foreign Application Priority Data
Aug. 7, 2020 (CN) 202010788309.7

(51) Int. Cl. B60R 19/48; B60R 21/0136; B60R 19/03; B60R 19/30

(52) U.S. Cl. CPC B60R 19/483; B60R 21/0136; B60R 2019/247; B60R 19/30; B60R 19/03

(57) ABSTRACT

A mobile platform including a vehicle body, an elastic anti-collision strip and two trigger mechanisms is provided. The vehicle body has two side surfaces and a front side surface connected between the two side surfaces. A safety network is provided in the vehicle body. The elastic anti-collision strip includes an impact receiving section and two fixing sections respectively connected to the impact receiving section. The impact receiving section is arc-shaped and located on the front side surface. The two fixing sections are respectively fixed to the two side surfaces. The two trigger mechanisms are respectively fixed to the two side surfaces and connected to the two fixing sections. The trigger mechanisms are used to trigger the safety network according to a deformation condition of the impact receiving section. The two fixing sections are used to control the deformation condition. A driving method of the mobile platform is also provided.

### CROSS-REFERENCE TO RELATED APPLICATION

This application claims the priority benefit of China application CN202010788309.7, filed on Aug. 07, 2020. The entirety of the above-mentioned patent application is hereby incorporated by reference herein and made a part of this specification.

### FIELD OF THE INVENTION

The invention relates to a mobile platform and a driving method thereof, and more particularly to a mobile platform equipped with an elastic anti-collision strip and a driving method thereof.

### BACKGROUND OF THE INVENTION

Mobile platforms, such as self-driving vehicles, have become indispensable important equipment in automated production. The mobile platform is mainly used in logistics transportation in automated production to reduce production costs and increase production efficiency.

In order to avoid collisions during transportation, a variety of obstacle detection networks are built in the mobile platform to automatically navigate and avoid obstacles. However, there may be unexpected objects on the transportation path, so the mobile platform is usually installed with a safety strip switch as the final safety means.

Pressure-sensitive safety strip switches are flexible and bendable. Common pressure-sensitive safety strip switches are fixed on the front and rear sides of the mobile platform in the form of elastic pressure strips and connected to the power supply of the mobile platform. When the mobile platform collides with an object or person that suddenly appears on the transportation route, the pressure-sensitive safety strip switch is squeezed and outputs a signal to turn off the power supply of the mobile platform, thereby immediately stopping the mobile platform to prevent the collision from continuing. However, the pressure-sensitive safety strip switch has the following problems for a long time.

The pressure-sensitive safety strip switch must correspond to the size of the mobile platform. When the width of the mobile platform is larger, a longer pressure-sensitive safety strip switch is required, and the longer pressure-sensitive safety strip switch is more expensive.

The pressure-sensitive safety strip switch must be fixed to the mobile platform by a fixing bracket. The fixed bracket may be damaged when a collision occurs, so that the pressure-sensitive safety strip switch may also lose its safety protection function. Even though the fixing bracket can be designed to be flexible in theory to avoid damage due to impact, the flexible fixing bracket may affect the sensitivity of the pressure-sensitive safety strip switch and also increase the complexity of the overall structure, thereby increasing the cost.

The pressure-sensitive safety strip switch is limited by the structure and is attached to the vehicle body of the mobile platform. If a collision occurs at a fast driving speed, usually a collision already happens even if the safety mechanism of the pressure-sensitive safety strip switch is triggered to immediately stop the mobile platform. Therefore, the pressure-sensitive safety strip switch has the problem of insufficient trigger distance. To increase the trigger distance of the pressure-sensitive safety strip switch, the fixing bracket supporting the pressure-sensitive safety strip switch must be extended, which increases the cost.

In addition, the pressure-sensitive safety strip switch must adopt a conversion substrate to convert the pressure-sensitive change into a normally open contact and a normally closed contact, thereby being connected to the power supply of the mobile platform. Additional costs are required to install the conversion substrate. In addition, such a structure often fails.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides a mobile platform, which has lower cost, more stable safety protection, a structure that is not easy to damage and malfunction, and a more sufficient early warning distance than the existing pressure-sensitive safety strip switch.

The invention provides a driving method of a mobile platform, which has lower cost, more stable safety protection, a structure that is not easy to damage and malfunction, and a more sufficient early warning distance than the existing pressure-sensitive safety pressure strip switch.

Other advantages and objects of the invention may be further illustrated by the technical features broadly embodied and described as follows.

In order to achieve one or a portion of or all of the objects or other objects, an embodiment of the invention provides a mobile platform, which includes a vehicle body, an elastic anti-collision strip and two trigger mechanisms. The vehicle body has two side surfaces and a front side surface. The two side surfaces are opposite to each other. The front side surface is connected between the two side surfaces. A safety network is provided in the vehicle body. The elastic anti-collision strip includes an impact receiving section and two fixing sections respectively connected to two ends of the impact receiving section. The impact receiving section is arc-shaped and located on the front side surface of the vehicle body. The two fixing sections are respectively fixed to the two side surfaces of the vehicle body. The two trigger mechanisms are respectively fixed to the two side surfaces of the vehicle body and connected to the two fixing sections. The trigger mechanisms are used to trigger the safety network according to a deformation condition of the impact receiving section. The two fixing sections are used to control the deformation condition to trigger the safety network.

In order to achieve one or a portion of or all of the objects or other objects, an embodiment of the invention provides a driving method of a mobile platform. The mobile platform includes a vehicle body, an elastic anti-collision strip and two trigger mechanisms. The driving method includes: sensing a deformation condition of the elastic anti-collision strip through the two trigger mechanisms; and triggering a safety network through the impact receiving section and the two fixing sections of the elastic anti-collision strip when the elastic anti-collision strip is deformed.

The mobile platform and the driving method of the embodiment of the invention use the elastic anti-collision strip as an element to withstand the impact. Compared with the pressure-sensitive safety strip switch in the prior art, the elastic anti-collision strip has a lower cost. In addition, the impact receiving section of the elastic anti-collision strip is arc-shaped and located on the front side of the mobile platform, thus the elastic anti-collision strip has a larger warning distance than the pressure-sensitive safety strip in the prior art. In addition, the elastic anti-collision strip can withstand large deformations and is not easy to be damaged after an impact, and therefore the elastic anti-collision strip can continue to provide safety protection for the mobile platform when the obstacle is removed. In addition, the elastic anti-collision strip can be fixed to the mobile platform without a fixing bracket, thereby avoiding the disadvantage that the pressure-sensitive safety strip switch of the prior art cannot continue to provide safety protection due to the damage of the fixing bracket. In addition, the elastic anti-collision strip of the mobile platform of this embodiment triggers the safety network through the trigger mechanism, and the trigger mechanism is not provided with any rotating shaft mechanism, thereby avoiding mechanical failure caused by abrasion and oil contamination and therefore having a high degree of durability. In addition, according to different task requirements, the elastic anti-collision strips of different lengths can be selected and the trigger mechanism can be fine-tuned without frequently changing the design of the trigger mechanism. In addition, the normally open contact and the normally closed contact can be directly connected between the trigger mechanism and the safety network of the mobile platform, so as to improve the prior art in which the signal of the pressure-sensitive safety strip must be converted by the conversion substrate, resulting in increased cost and the shortcomings of easy failure.

Other objectives, features and advantages of The invention will be further understood from the further technological features disclosed by the embodiments of The invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic block diagram of a mobile platform according to an embodiment of the invention;

FIG. 1B is a schematic top diagram of a mobile platform according to an embodiment of the invention;

FIG. 1C is an enlarged schematic diagram of area A in FIG. 1B;

FIGS. 1D and 1E respectively is a schematic diagram of an elastic anti-collision strip deformed when subjected to an impact in an embodiment of the invention;

FIGS. 1F and 1G respectively is a schematic diagram of an action of the deformation sensing member and the elastic anti-collision strip under the deformation of the elastic anti-collision strip corresponding to FIGS. 1D and 1E; and

FIG. 2 is a flowchart of a driving method of a mobile platform according to an embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

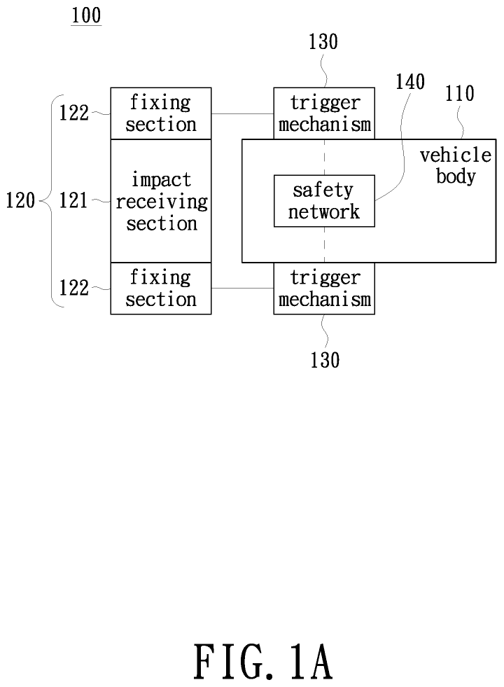

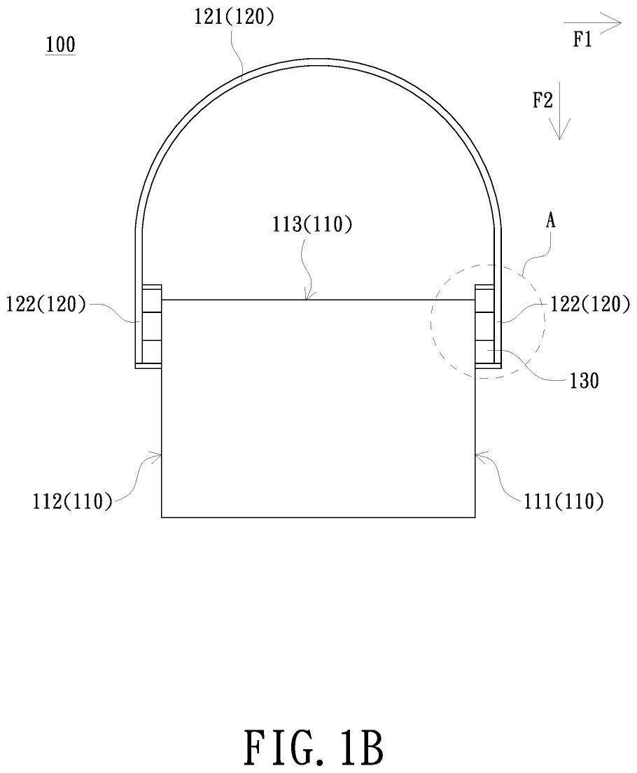

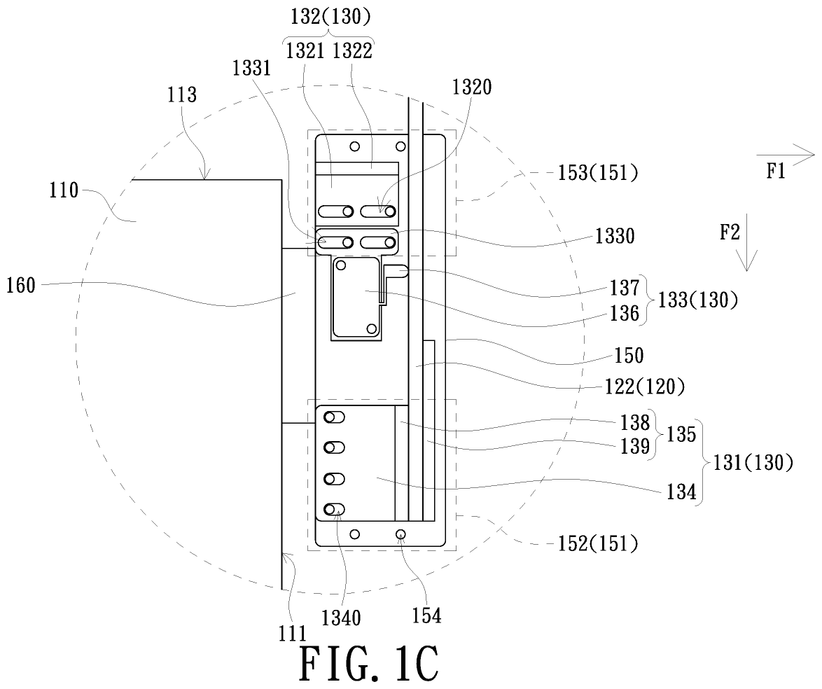

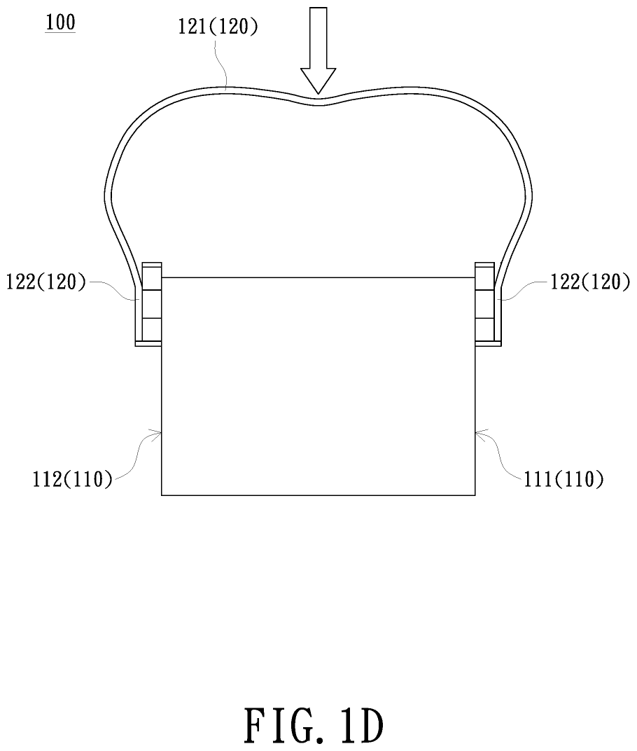

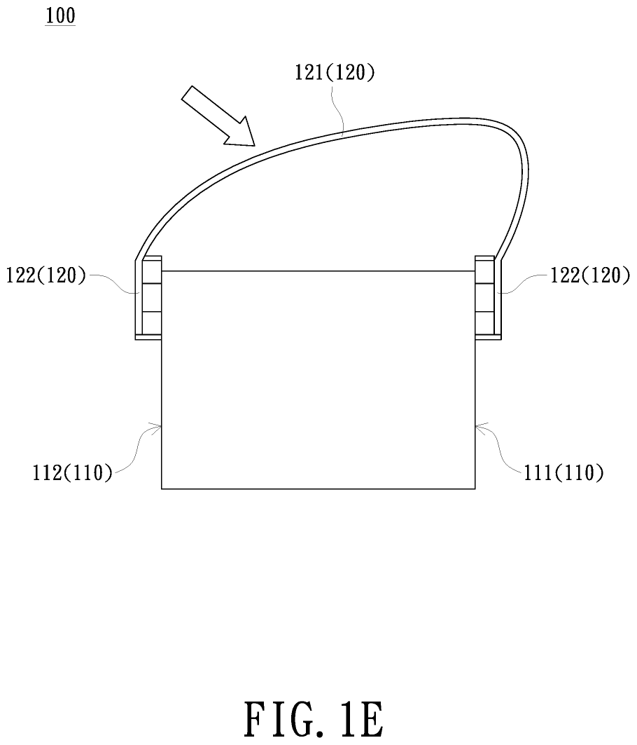

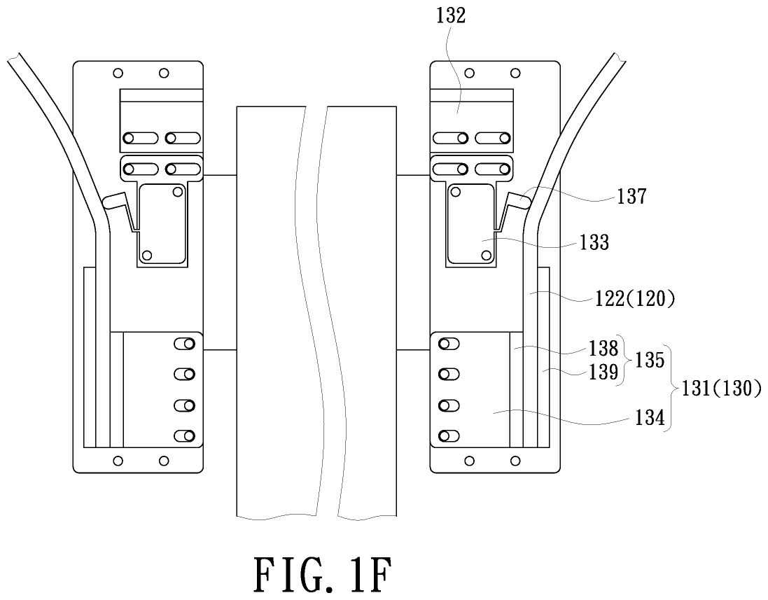

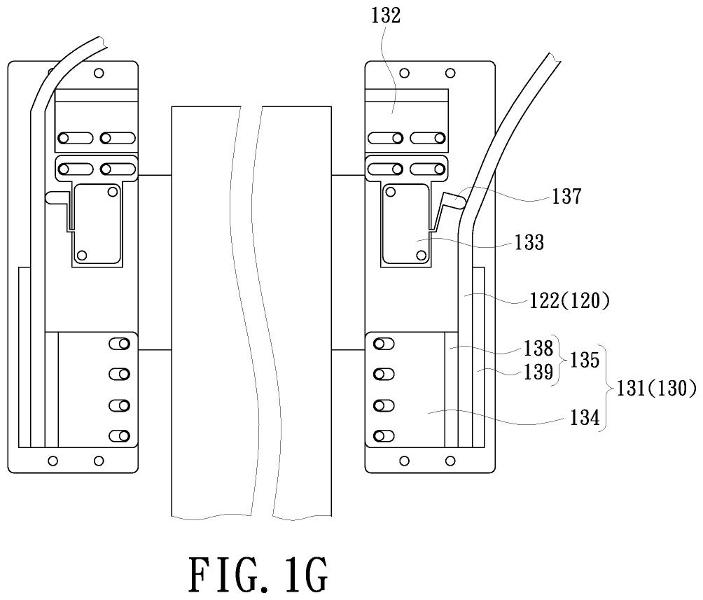

FIG. 1A is a schematic block diagram of a mobile platform according to an embodiment of the invention. FIG. 1B is a schematic top diagram of a mobile platform according to an embodiment of the invention. FIG. 1C is an enlarged schematic diagram of area A in FIG. 1B. Please refer to FIGS. 1A to 1C. The mobile platform 100 of this embodiment includes a vehicle body 110, an elastic anti-collision strip 120 and two trigger mechanisms 130. The vehicle body 110 has two side surfaces 111, 112 and a front side surface 113. The side surfaces 111, 112 are opposite to each other, and the front side surface 113 is connected between the side surfaces 111 and 112. A safety network 140 is provided in the vehicle body 110. The elastic anti-collision strip 120 includes an impact receiving section 121 and two fixing sections 122 respectively connected to two ends of the impact receiving section 121. The impact receiving section 121 is arc-shaped and located on the front side surface 113 of the vehicle body 110, and the two fixing sections 122 are respectively fixed to the side surfaces 111 and 112 of the vehicle body 110. The two trigger mechanisms 130 are respectively fixed to the side surfaces 111 and 112 of the vehicle body 110 and connected to the two fixing sections 122. Each of the trigger mechanisms 130 is used to trigger the safety network 140 according to the deformation condition of the impact receiving section 121. The two fixing sections 122 are used to control the deformation condition to correctly trigger the safety network 140.

In this embodiment, the elastic anti-collision strip 120 is an integrally-formed elastic body, such as a spring steel strip or an elastic plastic strip, but is not limited thereto. In another embodiment, the elastic anti-collision strip 120 may also be a composite-formed elastic body to provide nonlinear elastic deformation. When the mobile platform 100 is in contact with an obstacle (not shown) and collides, the elastic anti-collision strip 120 can protect the mobile platform 100 and the obstacle through temporary deformation and avoid direct collision between the mobile platform 100 and the obstacle. When the mobile platform 100 is separated from the obstacle, the elastic anti-collision strip 120 can be restored to its original state and continue to provide protection for the mobile platform 100.

The safety network 140 may be an electrical network and include a plurality of circuits or electronic devices and electronic components connected to each other to provide a path for the flow of electric charges. In this embodiment, the safety network 140 can be used to turn off or turn on the power of the mobile platform 100, but is not limited thereto. The electrical network similar to the safety network 140 is a common technology in the field of mobile platforms, so no redundant detail is to be given herein.

In this embodiment, the mobile platform 100 further includes a substrate 150. Each of the side surfaces 111 and 112 of the vehicle body 110 may be fixed with one substrate 150. Taking the substrate 150 fixed to the side surface 111 as an example, the substrate 150 has a carrying surface 151. The carrying surface 151 is used to carry one of the two fixing sections 122 and has a first configuration area 152 and a second configuration area 153 spaced apart from each other. The first configuration area 152 is farther away from the impact receiving section 121 than the second configuration area 153. The carrying surface 151 of the substrate 150 may have a plurality of fixing holes 154. The mobile platform 100 of this embodiment may further include a fixing sheet 160 connected between the substrate 150 and the vehicle body 110. The fixing sheets 160 are used to fix the two substrates 150 to the side surfaces 111 and 112 of the vehicle body 110 respectively.

In this embodiment, each of the two trigger mechanisms 130 includes a fixing assembly 131, a tension adjusting member 132 and a deformation sensing member 133. The fixing assembly 131 includes a fixing body 134 and a connecting portion 135. The fixing body 134 is fixed to the first configuration area 152, and the connecting portion 135 is connected to the respective fixing section 122. The tension adjusting member 132 is fixed to the second configuration area 153. The deformation sensing member 133 includes a sensing body 136 and a trigger portion 137. The sensing body 136 is fixed on the carrying surface 151 of the substrate 150 and is located between the first configuration area 152 and the second configuration area 153. The sensing body 136 is electrically connected to the safety network 140. The trigger portion 137 protrudes from one side of the sensing body 136 and contacts the respective fixing section 122.

In this embodiment, the fixing body 134 of the fixing assembly 131 is used to move along the first direction F1 and the second direction F2, and can be fixed at a plurality of different positions in the first configuration area 152. The first direction F1 is a direction approaching or away from the respective side surface of the vehicle body 110 (e.g., the side surface 111 in the area A). The second direction F2 is a direction approaching or away from the second configuration area 153, and the connecting portion 135 can be connected to different parts of the respective fixing section 122 along the second direction F2. Specifically, when the connecting portion 135 is connected to the part of the fixing section 122 closer to the end of the fixing section 122, the impact receiving section 121 has a lower tension and can have a larger amount of deformation. Conversely, when the connecting portion 135 is connected to the part of the fixing section 122 farther from the end of the fixing section 122, the impact receiving section 121 has a larger tension; that is, the impact receiving section 121 is tighter. The tension of the impact receiving section 121 can be adjusted according to different requirements.

The fixing body 134 of the fixing assembly 131 may have a plurality of slots 1340 corresponding to the fixing holes 154 of the substrate 150. The fixing body 134 is fixed on the substrate 150 by the slots 1340, the fixing holes 154, and the coupling members (e.g., screws or rivets, not shown) passing through the slots 1340 and the fixing holes 154. The length of the slot 1340 in the first direction F1 is greater than that of the fixing hole 154 of the substrate 150, so the fixing body 134 can adjust its position in the first direction F1 as required. In addition, the fixing body 134 can also adjust its position in the second direction F2 through the fixing holes 154 in the second direction F2. However, the invention is not limited to this, and the fixing assembly 131 can also adjust its position on the substrate 150 in other ways.

In this embodiment, the connecting portion 135 of the fixing assembly 131 may include a first clamping piece 138 and a second clamping piece 139, and the respective fixing section 122 is clamped between the first clamping piece 138 and the second clamping piece 139. The first clamping piece 138 is adjacent to and connected to the fixing body 134, and the second clamping piece 139 is connected to the first clamping piece 138. The length of the second clamping piece 139 in the second direction F2 is greater than that of the first clamping piece 138. The connecting portion 135 may further include a plurality of coupling members (not shown) passing through the first clamping piece 138 and the second clamping piece 139. The coupling member may be, for example, a screw or a rivet, but is not limited thereto.

The tension adjusting member 132 is used to adjust the trigger range of the impact receiving section 121 and the two fixing sections 122 of the elastic anti-collision strip 120. The tension adjusting member 132 includes a base piece 1321 fixed in the second configuration area 153 and an abutting piece 1322 integrally bent on the base piece 1321. The abutting piece 1322 is used to stop the respective fixing section 122 when the impact receiving section 121 of the elastic anti-collision strip 120 deforms. In this embodiment, the tension adjusting member 132 can move along the first direction Fl and be fixed at a plurality of different positions in the second configuration area 153, thereby adjusting the distance from the respective fixing section 122. In FIG. 1C, there is an interval between the abutting piece 1322 of the tension adjusting member 132 and the respective fixing section 122, but it is not limited thereto. In response to different requirements, the abutting piece 1322 of the tension adjusting member 132 can also abut against the respective fixing section 122 while the elastic anti-collision strip 200 is not impacted.

The tension adjusting member 132 and the second clamping piece 139 of the connecting portion 135 may be located on opposite sides of the respective fixing section 122. Specifically, the fixing assembly 131 and the tension adjusting member 132 are configured such that the second clamping piece 139 and the tension adjusting member 132 respectively abut on opposite sides of the respective fixing section 122 to deform the respective fixing section 122. When the impact receiving section 121 of the elastic anti-collision strip 120 deforms, the fixing assembly 131 and the tension adjusting member 132 are used to limit the amount of deformation of the impact receiving section 122, so that the trigger portion 137 of the deformation sensing member 133 remains in contact with the respective fixing section 122. When an impact occurs, the impact point of the impact receiving section 121 of the elastic anti-collision strip 120 will generate a force arm relative to the fixing section 122. The movement of the tension adjusting member 132 in the first direction F1 can adjust the length of the force arm, thereby changing the trigger range.

The base piece 1321 of the tension adjusting member 132 may have a plurality of slots 1320 corresponding to the fixing holes 154 of the substrate 150. The tension adjusting member 132 is fixed on the substrate 150 by the slots 1320, the fixing holes 154, and the coupling members (e.g., screws or rivets, not shown) passing through the slots 1320 and the fixing holes 154. The length of the slot 1320 in the first direction F1 is greater than that of the fixing hole 154 of the substrate 150, so the tension adjusting member 132 can adjust its position in the first direction F1 as required. However, the invention is not limited to this, and the tension adjusting member 132 can also adjust its position on the substrate 150 in other ways.

In this embodiment, the deformation sensing member 133 is a micro switch, and the trigger portion 137 protrudes from one side of the sensing body 136 telescopically. In another embodiment, the deformation sensing member 133 may be any displacement trigger switch. In response to the different configurations of the fixing assembly 131 and the tension adjusting member 132, the sensing body 136 of the deformation sensing member 133 can also move along the first direction F1 and be fixed at a plurality of different positions on the carrying surface 151 of the substrate 150, so that the trigger portion 137 remains in contact with the respective fixing section 122. A normally open contact and a normally closed contact can be directly provided between the deformation sensing member 133 and the safety network 140.

The trigger mechanism 130 of this embodiment may further include a carrying piece 1330. The sensing body 136 of the deformation sensing member 133 is fixed on the carrying piece 1330. The carrying piece 1330 may have a plurality of slots 1331 corresponding to the fixing holes 154 of the substrate 150. The carrying piece 1330 is fixed on the substrate 150 by the slots 1331, the fixing holes 154, and the coupling members (e.g., screws or rivets, not shown) passing through the slots 1331 and the fixing holes 154. The length of the slot 1331 in the first direction F1 is greater than that of the fixing hole 154 of the substrate 150, so the carrying piece 1330 can adjust its position in the first direction F1 as required. However, the invention is not limited to this, and the deformation sensing member 133 can also adjust its position on the substrate 150 in other ways.

It can be seen from the above that each of the fixing sections 122 of the elastic anti-collision strip 120 can adjust the deformation condition of the impact receiving section 121 through the fixing assembly 131 and the tension adjusting member 132 to correctly trigger the deformation sensing member 133.

FIGS. 1D and 1E respectively is a schematic diagram of an elastic anti-collision strip deformed when subjected to an impact in an embodiment of the invention. FIGS. 1F and 1G respectively is a schematic diagram of an action of the deformation sensing member and the elastic anti-collision strip under the deformation of the elastic anti-collision strip corresponding to FIGS. 1D and 1E. Please refer to FIGS. 1A and 1D to 1G As shown in FIGS. 1D and 1F, when the center of the impact receiving section 121 of the elastic anti-collision strip 120 is deformed by an impact, the two fixing sections 122 will swing and remain in contact with the trigger portions 137 of the deformation sensing members 133 due to the restriction of the fixing assemblies 131 and the tension adjusting members 132. At this time, when the deformation sensing members 133 sense that the swing displacement of any one of the two fixing sections 122 reaches a preset value, the safety network 140 is activated and the mobile platform 100 is stopped.

As shown in FIGS. 1E and 1G, when the impact receiving section 121 of the elastic anti-collision strip 120 is impacted at a part closer to the fixing section 122 (i.e., at the diagonal front of the mobile platform 100), the two fixing sections 122 swing accordingly, and at least one of the two fixing sections 122 remains in contact with the trigger portion 137 of the deformation sensing member 133 due to the restriction of the fixing assembly 131 and the tension adjusting member 132. At this time, when the deformation sensing members 133 sense that the swing displacement of any one of the two fixing sections 122 reaches a preset value, the safety network 140 is activated and the mobile platform 100 is stopped. It is conceivable that the mobile platform 100 can be forcibly stopped when the trigger portion 137 of any deformation sensing member 133 temporarily detaches from the respective fixing section 122 due to a violent impact.

The mobile platform 100 of this embodiment uses the elastic anti-collision strip 120 as an element to withstand an impact. Compared with the pressure-sensitive safety strip switch in the prior art, the elastic anti-collision strip 120 has a lower cost. In addition, the impact receiving section 121 of the elastic anti-collision strip 120 is arc-shaped and located on the front side of the mobile platform 100, thus the elastic anti-collision strip 120 has a larger warning distance than the pressure-sensitive safety strip in the prior art. In addition, the elastic anti-collision strip 120 can withstand large deformations and is not easy to be damaged after an impact, and therefore the elastic anti-collision strip 120 can continue to provide safety protection for the mobile platform 100 when the obstacle is removed. In addition, the elastic anti-collision strip 120 can be fixed to the mobile platform 100 without a fixing bracket, thereby avoiding the disadvantage that the pressure-sensitive safety strip switch of the prior art cannot continue to provide safety protection due to the damage of the fixing bracket. In addition, the elastic anti-collision strip 120 of the mobile platform 100 of this embodiment triggers the safety network 140 through the trigger mechanism 130, and the trigger mechanism 130 is not provided with any rotating shaft mechanism, thereby avoiding mechanical failure caused by abrasion and oil contamination and therefore having a high degree of durability. In addition, the normally open contact and the normally closed contact can be directly connected between the trigger mechanism 130 and the safety network 140 of the mobile platform 100, so as to improve the prior art in which the signal of the pressure-sensitive safety strip must be converted by the conversion substrate, resulting in increased cost and the shortcomings of easy failure.

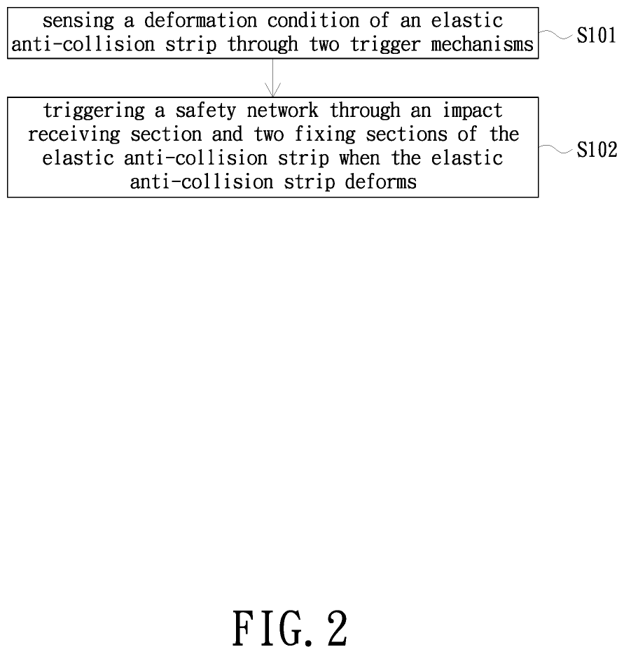

FIG. 2 is a flowchart of a driving method of a mobile platform according to an embodiment of the invention. Referring to FIGS. 1A, 1B and 2, the driving method of a mobile platform of this embodiment can be used for the mobile platform 100 and include the following steps.

Step S101: sensing a deformation condition of the elastic anti-collision strip 120 through the two trigger mechanisms 130. The two trigger mechanisms 130 continuously sense whether the elastic anti-collision strip 120 is deformed while the mobile platform 100 is running As can be seen from the above embodiments of the mobile platform 100, the fixing assemblies 131 of the two trigger mechanisms 130 respectively fix the fixing sections 122 and provide tension, and the tension adjusting member 132 further adjusts the tension of the respective fixing section 122, and the deformation sensing member 133 is used to monitor the deformation conditions of the elastic anti-collision strip 120.

Step S102: triggering the safety network 140 through the impact receiving section 121 and the two fixing sections 122 of the elastic anti-collision strip 120 when the elastic anti-collision strip 120 deforms. As can be seen from the embodiments in FIGS. 1A to 1G, the trigger range of the impact receiving section 121 and the two fixing sections 122 of the elastic anti-collision strip 120 can be adjusted through the tension adjusting member 132. Specifically, the tension adjusting member 132 is used to adjust the length of force arm between the impacted point of the impact receiving section 121 of the elastic anti-collision strip 120 and the fixing assembly 131. Under any impact, the swing of the fixing section 122 of the elastic anti-collision strip 120 is within the range that can be sensed by the deformation sensing member 133, so that all the deformation conditions of the impact receiving section 121 are within the expected range of the two trigger mechanisms 130.

The mobile platform and the driving method of the embodiment of the invention use the elastic anti-collision strip as an element to withstand the impact. Compared with the pressure-sensitive safety strip switch in the prior art, the elastic anti-collision strip has a lower cost. In addition, the impact receiving section of the elastic anti-collision strip is arc-shaped and located on the front side of the mobile platform, thus the elastic anti-collision strip has a larger warning distance than the pressure-sensitive safety strip in the prior art. In addition, the elastic anti-collision strip can withstand large deformations and is not easy to be damaged after an impact, and therefore the elastic anti-collision strip can continue to provide safety protection for the mobile platform when the obstacle is removed. In addition, the elastic anti-collision strip can be fixed to the mobile platform without a fixing bracket, thereby avoiding the disadvantage that the pressure-sensitive safety strip switch of the prior art cannot continue to provide safety protection due to the damage of the fixing bracket. In addition, the elastic anti-collision strip of the mobile platform of this embodiment triggers the safety network through the trigger mechanism, and the trigger mechanism is not provided with any rotating shaft mechanism, thereby avoiding mechanical failure caused by abrasion and oil contamination and therefore having a high degree of durability. In addition, according to different task requirements, the elastic anti-collision strips of different lengths can be selected and the trigger mechanism can be fine-tuned without frequently changing the design of the trigger mechanism. In addition, the normally open contact and the normally closed contact can be directly connected between the trigger mechanism and the safety network of the mobile platform, so as to improve the prior art in which the signal of the pressure-sensitive safety strip must be converted by the conversion substrate, resulting in increased cost and the shortcomings of easy failure.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “The invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first configuration area, the second configuration area, the first direction, the second direction, the first clamping piece, and the second clamping piece are only used for distinguishing various elements and do not limit the number of the elements.

What is claimed is:

1. A mobile platform, comprising a vehicle body, an elastic anti-collision strip and two trigger mechanisms, wherein:
the vehicle body has two side surfaces and a front side surface, the two side surfaces are opposite to each other, the front side surface is connected between the two side surfaces, and a safety network is provided in the vehicle body;
the elastic anti-collision strip comprises an impact receiving section and two fixing sections respectively connected to two ends of the impact receiving section, the impact receiving section is arc-shaped and located on the front side surface of the vehicle body, and the two fixing sections are respectively fixed to the two side surfaces of the vehicle body; and
the two trigger mechanisms are respectively fixed to the two side surfaces of the vehicle body and connected to the two fixing sections, and the trigger mechanisms are configured to trigger the safety network according to a deformation condition of the impact receiving section, wherein the two fixing sections are configured to control the deformation condition to trigger the safety network.

2. The mobile platform according to claim 1, further comprising:
a substrate, fixed to the two side surfaces of the vehicle body and having a carrying surface, wherein the carrying surface is configured to carry the two fixing sections and has a first configuration area and a second configuration area spaced apart from each other, and the first configuration area is farther from the impact receiving section than the second configuration area.

3. The mobile platform according to claim 2, wherein each of the two trigger mechanisms comprises a fixing assembly, a tension adjusting member and a deformation sensing member, wherein
fixing assembly comprises a fixing body and a connecting portion, the fixing body is fixed to the first configuration area, and the connecting portion is connected to the respective fixing section;
the tension adjusting member is fixed to the second configuration area; and
the deformation sensing member comprises a sensing body and a trigger portion, the sensing body is fixed on the carrying surface of the substrate, and is located between the first configuration area and the second configuration area, and is electrically connected to the safety network, and the trigger portion protrudes from one side of the sensing body and contacts the respective fixing section.

4. The mobile platform according to claim 3, wherein the fixing body is configured to move along a first direction and a second direction and be fixed at a plurality of different positions in the first configuration area, the first direction is a direction approaching or away from the respective side surface of the vehicle body, the second direction is a direction approaching or away from the second configuration area, and the connecting portion is connected to different parts of the respective fixing section along the second direction.

5. The mobile platform according to claim 4, wherein the tension adjusting member is configured to move along the first direction and be fixed at a plurality of different positions in the second configuration area to adjust a distance from the respective fixing section.

6. The mobile platform according to claim 5, wherein the connecting portion of the fixing assembly comprises a first clamping piece and a second clamping piece, the respective fixing section is clamped between the first clamping piece and the second clamping piece, the first clamping piece is adjacent to and connected to the fixing body, and the second clamping piece is connected to the first clamping piece.

7. The mobile platform according to claim 6, wherein the second clamping piece and the tension adjusting member are respectively located on opposite sides of the respective fixing section, and a length of the second clamping piece in the second direction is greater than a length of the first clamping piece.

8. The mobile platform according to claim 7, wherein the fixing assembly and the tension adjusting member are configured to make the second clamping piece and the tension adjusting member respectively abut against the opposite sides of the respective fixing section, thereby deforming the respective fixing section.

9. The mobile platform according to claim 3, wherein the trigger portion protrudes from one side of the sensing body telescopically, and when the impact receiving section of the elastic anti-collision strip deforms, the fixing assembly and the tension adjusting member are configured to limit an amount of deformation of the impact receiving section, so that the trigger portion remains in contact with the respective fixing section.

10. The mobile platform according to claim 3, wherein the sensing body of the deformation sensing member is configured to move in a first direction approaching or away from the respective vehicle body and be fixed at a plurality of different positions on the carrying surface of the substrate.

11. The mobile platform according to claim 3, wherein the deformation sensing member is a micro switch or a displacement trigger switch.

12. The mobile platform according to claim 3, wherein the tension adjusting member comprises a base piece fixed in the second configuration area and an abutting piece integrally bent on the base piece, and the abutting piece is configured to stop the respective fixing section when the impact receiving section of the elastic anti-collision strip is deformed.

13. The mobile platform according to claim 1, wherein the elastic anti-collision strip is an integrally-formed or composite-formed elastic body.

14. A driving method of a mobile platform, the mobile platform comprising a vehicle body, an elastic anti-collision strip and two trigger mechanisms, and the driving methods comprising:
sensing a deformation condition of the elastic anti-collision strip through the two trigger mechanisms; and
triggering a safety network through the impact receiving section and the two fixing sections of the elastic anti-collision strip when the elastic anti-collision strip is deformed.

15. The driving method according to claim 14, further comprising:
adjusting a trigger range of the impact receiving section and the two fixing sections through tension adjusting members of the two trigger mechanisms.
